(19) United States
(12) Patent Application Publication
(10) Pub. No.: US 2025/0015709 A1
(43) Pub. Date: Jan. 9, 2025

(54) GROUNDING METHOD FOR THREE-PHASE HIGH-FREQUENCY PULSE WIDTH MODULATION CURRENT SOURCE RECTIFIER CIRCUIT

(71) Applicant: Luoliang XUE, Zhengzhou (CN)

(72) Inventor: Luoliang XUE, Zhengzhou (CN)

(21) Appl. No.: 18/890,953

(22) Filed: Sep. 20, 2024

Related U.S. Application Data
(63) Continuation of application No. PCT/CN2022/082677, filed on Mar. 24, 2022.

(30) Foreign Application Priority Data
Jan. 21, 2022 (CN) 2022100745146

(51) Int. Cl. H02M 1/32; H02M 7/219

(52) U.S. Cl. CPC H02M 1/32; H02M 7/219

(57) ABSTRACT

A grounding method for a three-phase high-frequency PWM CSR circuit, includes: connecting the three-phase high-frequency PWM CSR circuit in a non-direct grounding neutral circuit of a low-voltage winding of a transformer; connecting a first capacitor C4 and a second capacitor C41 between positive and negative DC busbars of the three-phase high-frequency PWM CSR circuit, where the first capacitor C4 and the second capacitor C41 are connected in series with equal capacitances; and arranging a control grounding point at a midpoint between the first capacitor and the second capacitor to stabilize and balance voltages of the positive and negative DC busbars relative to ground. The grounding method can stabilize and balance the voltages of the positive and negative DC busbars relative to ground output of the three-phase high-frequency PWM CSR circuit, reduce energy consumption, and make the three-phase high-frequency PWM CSR circuit safe and reliable to use.

### CROSS-REFERENCE TO RELATED APPLICATIONS

This application is a continuation of International Patent Application No. PCT/CN2022/082677, filed on Mar. 24, 2022, which claims the priority of Chinese Patent Application No. CN202210074514.6, filed on Jan. 21, 2022, both of which are herein incorporated by reference in their entirety.

### TECHNICAL FIELD

The disclosure relates to the field of high-frequency pulse width modulation (PWM) current source rectifier (CSR) circuits, and more particularly to a grounding method for a three-phase high-frequency PWM CSR circuit.

### BACKGROUND

A three-phase high-frequency PWM CSR circuit is a current-source buck-type pulse-width modulation rectifier circuit (also known as a buck rectifier circuit). High-power rectifier circuits all adopt a three-phase input power supply. A schematic diagram of the three-phase high-frequency PWM CSR circuit is shown in FIG. 1, the three-phase high-frequency PWM CSR circuit has a power factor correction (PFC) function that can greatly improve an input power factor. At the same time, harmonic waves generated by the three-phase high-frequency PWM CSR circuit are very small, and an output power control accuracy is high, thereby making the three-phase high-frequency PWM CSR circuit widely used in rectifier circuits.

The three-phase high-frequency PWM CSR circuit in the related art achieves high-frequency PWM operation through high-power switch tubes. In the related art, a neutral point of a low-voltage winding of a distribution transformer electrically connected to the three-phase high-frequency PWM CSR circuit is mainly grounded as protective grounding, as shown by a dashed box 3 in FIG. 1; and control groundings of a control circuit electrically connected to the three-phase high-frequency PWM CSR circuit also uses the same grounding, as shown by dashed boxes 4 and 5 in FIG. 1. The commutation of the three-phase high-frequency PWM CSR circuit) is performed between upper and lower bridge arm switch tubes of adjacent phases. In FIGS. 1, V1, V2 and V3 respectively represent the upper bridge arm switch tubes for a phase A, a phase B and a phase C, and V4, V5 and V6 respectively represent the lower bridge arm switch tubes for the phase A, the phase B and the phase C. For example, when the switch tube V1 of an upper bridge arm is turned on, either the switch tube V5 or the switch tube V6 of the lower bridge arm is turned on, and actions of the other switch tubes follow suit. A voltage of each phase of a three-phase alternating current (AC) power relative to ground changes over time, and the conduction of each switch tube clamps voltages of positive and negative direct current (DC) busbars, causing voltage values of the positive and negative DC busbars relative to ground to change with the turn-on or turn-off of each switch tube. This makes it impossible to supply power to loads that require the voltages of the positive and negative DC busbars relative to ground to be stable and balanced.

### SUMMARY

In view of this, the disclosure provides a grounding method for a three-phase high-frequency PWM CSR circuit that can stabilize and balance voltages of positive and negative DC busbars relative to ground output of the three-phase high-frequency PWM CSR circuit, reduce energy consumption, and make the three-phase high-frequency PWM CSR circuit safe and reliable to use.

In order to achieve purposes of the disclosure, the following technical solutions can be adopted.

The grounding method for the three-phase high-frequency PWM CSR circuit includes:
connecting the three-phase high-frequency PWM CSR circuit in a non-direct grounding neutral circuit of a secondary winding (i.e., a low-voltage winding) of a transformer of the three-phase high-frequency PWM CSR circuit;
connecting a first capacitor and a second capacitor between positive and negative DC busbars of the three-phase high-frequency PWM CSR circuit, where capacitances of the first capacitor and the second capacitor are equal, and the first capacitor and the second capacitor are connected in series; and
arranging a control grounding point at a midpoint between the first capacitor and the second capacitor to stabilize and balance voltages of the positive and negative DC busbars relative to ground.

The disclosure has the following beneficial effects. 1. The disclosure utilizes the three-phase high-frequency PWM CSR circuit in the non-direct grounding neutral circuit of the low-voltage winding of the transformer, where the first capacitor and the second capacitor with equal capacitances are connected in series between the positive and negative DC busbars of the three-phase high-frequency PWM CSR circuit. The control grounding point is set at the midpoint between the first capacitor C4 and the second capacitor C41 to stabilize and balance the voltages of the positive and negative DC busbars relative to the ground, thereby reducing losses. 2. The disclosure saves energy consumption, reduces costs, and extends the service life. 3. The disclosure represents a technological upgrade over the related art and is suitable for widespread promotion.

### BRIEF DESCRIPTION OF DRAWINGS

FIG. 1 illustrates a circuit diagram of a three-phase high-frequency PWM CSR circuit in the related art.

FIG. 2 illustrates a circuit diagram of a three-phase high-frequency PWM CSR circuit of a grounding method for the three-phase high-frequency PWM CSR circuit according to an embodiment of the disclosure.

Description of reference numerals: 1: distribution transformer; 2: CSR circuit; 3: first protective grounding; 4: first control grounding; 5: second control grounding; 6: second protective grounding; 7: third control grounding; 8: fourth control grounding; 9: fifth control grounding; 10: selected grounding point.

### DETAILED DESCRIPTION OF EMBODIMENTS

A further detailed explanation of the disclosure is provided below in conjunction with the accompanying drawings and embodiments of the disclosure.

The technical solutions in the embodiments of the disclosure are clearly and completely described below in conjunction with the accompanying drawings. Apparently, the described embodiments are only a part of embodiments of the disclosure, not all of them. Based on the embodiments of the disclosure, all other embodiments obtained by those skilled in the art without creative labor are within the scope of protection of the disclosure.

It should be noted that all directional indications (such as up, down, left, right, front and back, etc.) in the embodiments of the disclosure are only used to explain the relative position relationship and motion, etc. between components in a specific posture (as shown in the attached drawings). If the specific posture changes, the directional indication will also change accordingly.

In the disclosure, unless otherwise expressly specified and limited, terms, such as “connected” and “fixed”, etc. should be understood in a broad sense, e.g., “fixed” can be a fixed connection, a removable connection or a one-piece connection; it can be a mechanical connection or an electrical connection; it can be a direct connection or an indirect connection through an intermediate medium; it can be a connection within two elements or an interaction between two elements. Unless expressly limited otherwise, for those skilled in the art, specific meanings of above terms in the disclosure may be understood on a case-by-case basis.

In addition, if there are descriptions related to “first” and “second” etc. in the embodiments of the disclosure, such descriptions are only for descriptive purposes and cannot be understood as indicating or implying their relative importance or implying the number of indicated technical features. Therefore, features defined with “first” and “second” can explicitly or implicitly include at least one of these features. In addition, the meaning of “and/or” appearing throughout the disclosure includes three parallel schemes. Taking “A and/or B” as an example, it includes a scheme A, or a scheme B, or a scheme that both A and B satisfy. Furthermore, the technical solutions of various embodiments can be combined with each other, but must be based on that those skilled in the art can achieve. When the combination of the technical solutions conflicts with each other or cannot be achieved, it should be considered that the combination of the technical solutions does not exist and is not within the scope of protection claimed by the disclosure.

### Embodiment 1

The embodiment of the disclosure provides a grounding method for a three-phase high-frequency PWM CSR circuit.

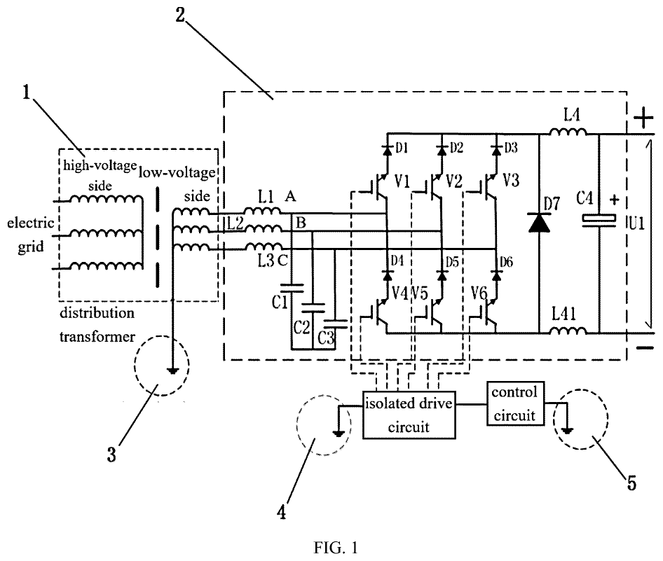

Referring to FIG. 1, in the related art, a three-phase high-frequency PWM CSR circuit achieves high-frequency PWM operation through high-power switch tubes. The three-phase high-frequency PWM CSR circuit includes a distribution transformer 1 and a CSR circuit 2. The distribution transformer 1 includes a first protective grounding 3, which is actually the grounding of a low-voltage winding. The CSR circuit 2 includes a first control grounding 4 and a second control grounding 5. In the related art, a neutral point of the low-voltage winding of the distribution transformer 1 is grounded as a protective grounding, such as the first protective ground 3.

As shown in FIG. 1, the CSR circuit 2 also uses same groundings for control groundings in a control circuit, such as the first control ground 4 and the second control ground 5.

The commutation of the three-phase high-frequency PWM CSR circuit is performed between upper and lower bridge arm switch tubes of adjacent phases. In FIGS. 1, V1, V2 and V3 respectively represent the upper bridge arm switch tubes for a phase A, a phase B and a phase C, and V4, V5 and V6 respectively represent the lower bridge arm switch tubes for the phase A, the phase B and the phase C. For example, when the switch tube V1 of an upper bridge arm is turned on, either the switch tube V5 or the switch tube V6 of the lower bridge arm is turned on, and actions of the other switch tubes follow suit. A voltage of each phase of a three-phase AC power relative to ground changes over time, and the conduction of each switch tube clamps voltages of positive and negative DC busbars, causing voltage values of the positive and negative DC busbars relative to ground to change with the turn-on or turn-off of each switch tube. This makes it impossible to supply power to loads that require the voltages of the positive and negative DC busbars relative to ground to be stable and balanced.

In order to achieve a stable and balanced supply method for the voltages of the positive and negative DC busbars to ground, some innovations are made to the three-phase high-frequency PWM CSR circuit.

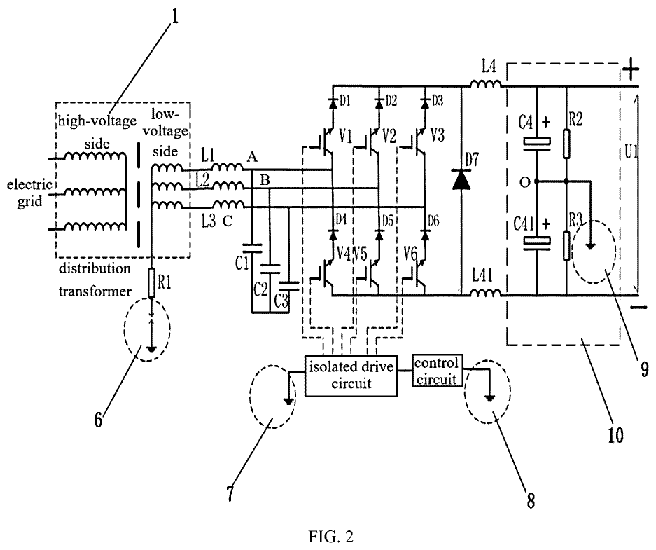

Referring to FIG. 2, in the disclosure, the neutral point of the low-voltage winding of the distribution transformer 1 used in the three-phase high-frequency PWM CSR circuit is grounded through a gap (or varistor), as shown in FIG. 2, by a second protective grounding 6. The second protective grounding 6 in reality means that the low-voltage winding is not grounded. Under normal working conditions, a neutral point circuit of the second protective grounding 6 is not grounded; and during overvoltage, the neutral point discharges to ground through the gap, acting as a protective ground.

The disclosure further includes a first capacitor C4 and a second capacitor C41 which are in series connection between the positive and negative DC busbars. Capacitances of the first capacitor C4 and the second capacitor C41 are equal. A control grounding point is set at a midpoint O between the first capacitor C4 and the second capacitor C41, and the control grounding point is a fifth control grounding 9 as shown in FIG. 2.

The fifth control grounding 9 is grounded at the midpoint O and the fifth control grounding 9 represents a grounding point. A selected grounding point 10 represents a grounding indication at the midpoint O, thereby achieving the purpose of stable and balanced the voltages of the positive and negative DC busbars to the ground.

In the embodiment, the first capacitor C4 and the second capacitor C41 are also used as filtering capacitors. Meanwhile, a first resistor R2 and a second resistor R3 with equal large resistances are connected in parallel at two ends of the first capacitor C4 and the second capacitor C41 to balance the voltage across the two capacitors.

In addition, the midpoint O also serves as a circuit control grounding. As shown in FIG. 2, the third control grounding 7, the fourth control grounding 8, and the midpoint O are connected as a common ground point, which can stabilize the voltages of the positive and negative DC busbars to the ground, reducing circuit noise and common-mode interference.

In order to obtain a stable and balanced supply method for the voltages of the positive and negative DC busbars to ground, in the disclosure, the neutral point of the low-voltage winding of the distribution transformer 1 used in the three-phase high-frequency PWM CSR circuit is grounded through the gap (or varistor), as shown in FIG. 2, by the second protective grounding 6. The second protective grounding 6 in reality means that the low-voltage winding is not grounded. Under normal working conditions, the neutral point circuit of the second protective grounding 6 is not grounded; and during overvoltage, the neutral point discharges to ground through the gap, acting as a protective ground. The first capacitor C4 and the second capacitor C41 are connected in series between the positive and negative DC busbars, and the midpoint O between the first capacitor C4 and the second capacitor C41 is grounded as the control grounding to stabilize and balance the voltages of the positive and negative DC busbars to ground.

Specifically, the grounding method for a three-phase high-frequency PWM CSR circuit includes: connecting the three-phase high-frequency PWM CSR circuit in a non-direct grounding neutral circuit of a secondary winding of a transformer of the three-phase high-frequency PWM CSR circuit; connecting a first capacitor C4 and a second capacitor C41 between positive and negative direct current DC busbars of the three-phase high-frequency PWM CSR circuit, where capacitances of the first capacitor C4 and the second capacitor C41 are equal, and the first capacitor C4 and the second capacitor C41 are connected in series; and arranging a control grounding point (i.e., the fifth control grounding 9 in the embodiment) at a midpoint O between the first capacitor C4 and the second capacitor C41 to stabilize and balance voltages of the positive and negative DC busbars relative to ground. As illustrated in FIG. 2, the non-direct grounding neutral circuit includes a resistor R1 and the second protective grounding 6 connected to the resistor R1.

Above are only optional embodiments of the disclosure, and is not intended to limit the scope of the patent of the disclosure, and any equivalent structural transformations made by utilizing contents of the specification and the accompanying drawings of the disclosure or directly/indirectly applied in other related art, under the invention concept, is included in the scope of the patent protection of the disclosure.

What is claimed is:

1. A grounding method for a three-phase high-frequency pulse width modulation (PWM) current source rectifier (CSR) circuit, the grounding method comprising:
connecting the three-phase high-frequency PWM CSR circuit in a non-direct grounding neutral circuit of a secondary winding of a transformer of the three-phase high-frequency PWM CSR circuit;
connecting a first capacitor (C4) and a second capacitor (C41) between positive and negative direct current (DC) busbars of the three-phase high-frequency PWM CSR circuit, wherein capacitances of the first capacitor and the second capacitor are equal, and the first capacitor and the second capacitor are connected in series; and
arranging a control grounding point at a midpoint between the first capacitor and the second capacitor to stabilize and balance voltages of the positive and negative DC busbars relative to ground.
